(19) United States
(12) Patent Application Publication
(10) Pub. No.: US 2019/0251469 A1
(43) Pub. Date: Aug. 15, 2019

(54) SYSTEM AND METHOD FOR EXTENDING MACHINE LEARNING TO EDGE DEVICES

(71) Applicant: Bsquare Corp., Bellevue, WA (US)

(72) Inventors: David Wagstaff, Lake Forest, CA (US); Matthew Thornton Honaker, Seattle, WA (US); Divya Krishnan, Bellevue, WA (US)

(21) Appl. No.: 16/275,061

(22) Filed: Feb. 13, 2019

Related U.S. Application Data
(60) Provisional application No. 62/629,861, filed on Feb. 13, 2018.

(51) Int. Cl. G06N 20/00; G06N 7/00

(52) U.S. Cl. CPC G06N 20/00; G06N 7/005

(57) ABSTRACT

A system and method for extending machine learning to edge devices is provided. Machine states, transitions and state values may be extracted from the machine state model. Remedial transitions may be extracted from the transitions based on the state values of the states, and a rule compactor may construct a miniaturized rule set from the machine states and the remedial transitions.

### CROSS REFERENCE TO RELATED APPLICATIONS

This application claims the benefit of U.S. provisional patent application Ser. No. 62/629,861, filed on Feb. 13, 2018, the contents of which are incorporated herein by reference in their entirety.

### BACKGROUND

Machine learning provides many great benefits which allow for the increase in efficiency and effectiveness of automated systems. For example, systems which are used to monitor telematics for vehicle fleets may employ machine learning and analytical techniques to allow for the prediction, avoidance, and remediation of mechanical issues with individual vehicles within the fleet. This information may be easily disbursed to servers and computer terminals to allow guidelines to be created about the fleet or provide general rules about how a vehicle should be operated. A problem arises when implementing these guidelines programmatically on an individual level. While a standard computer tower may be able to easily maintain, store and enact rules from a large data-rich guideline, smaller computing devices are not as able to deal with the large quantities of information necessary to enact those decisions. Continuing the vehicle example, a long-haul truck may not have the necessary computing resources to make second-to-second decisions based on a complex data-rich model, allowing more preventable wear and tear on the vehicle than is necessary.

### BRIEF SUMMARY

The present disclosure employs a system and method to gather, analyze and evaluate information from connected devices connected to a network. The present disclosure utilizes an embedded device server to transmit information from the connected device to an information system for further evaluation, and/or action when required. A module and/or embedded device may be associated with any specific connected device such that communication between the device and the information system may take place whereby information may be received by the information system to evaluate connected device functionality and other important characteristics as desired by the administrator.

A non-transitory computer-readable storage medium including instructions that when executed by a computer, cause the computer to: generate a machine state model for a machine system from device data comprising diagnostic parameter values received from at least one edge device, through operation of a state machine modeler and apply the machine state model to a rule compactor to construct a rule set. The applying of the machine state model to the rule compactor may comprise extracting a plurality of machine states, transitions, transition probabilities, and state values associated with each of the machine states from the machine state model; configuring a remediation parser with the state values to extract available remedial transitions for each of the machine states from the transitions based on the values of the state value for a starting state relative to an ending state; ranking the remedial transitions based on the transition probabilities associated with the remedial transition; and generating the rule set to encode the activation of the remedial transitions in rank order based upon the machine state. The instructions then instruct the computer to transmit the rule set to a communications engine client for transmission to an edge device.

Various objects, features, aspects and advantages of the present disclosure will become more apparent from the following detailed description of preferred embodiments of the invention, along with the accompanying drawing.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a system for extending machine learning to edge devices 100.

FIG. 2 illustrates an embodiment of a process for extending machine learning to edge devices 200.

FIG. 3 illustrates a routine for extending machine learning to edge devices in accordance with one embodiment.

FIG. 4 illustrates a training mode for a system 400 in accordance with one embodiment.

FIG. 5 illustrates an operational mode for a system 500 in accordance with one embodiment.

FIG. 6 illustrates an embodiment of a system for extending machine learning to edge devices 600.

FIG. 7 illustrates an embodiment of a finite state machine 700.

FIG. 8 illustrates a basic deep neural network 800 in accordance with one embodiment.

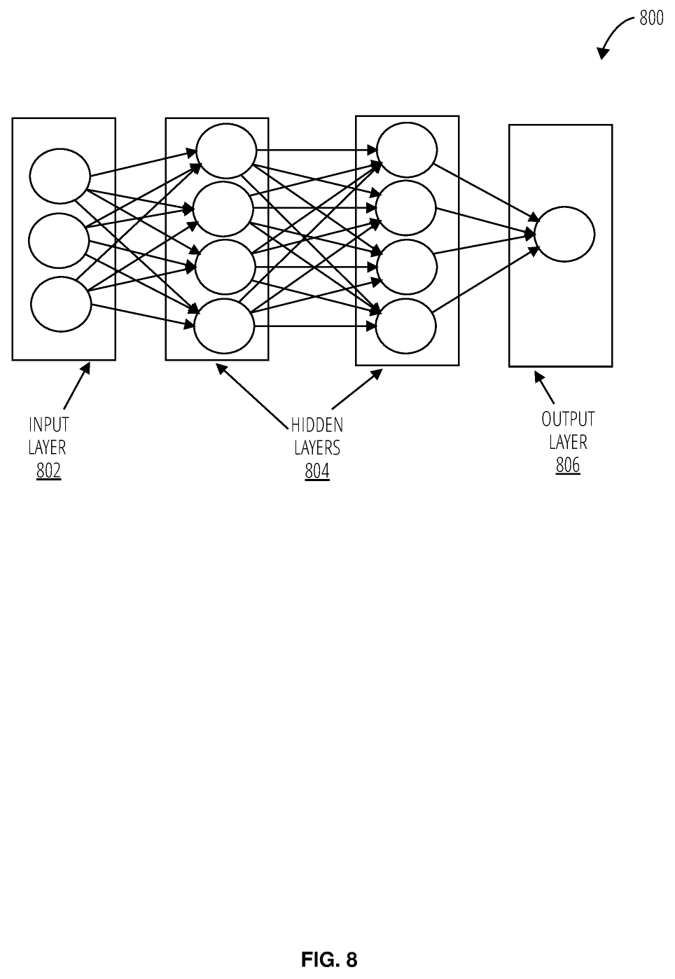

FIG. 9 illustrates an artificial neuron 900 in accordance with one embodiment.

FIG. 10 illustrates a system 1000 in accordance with one embodiment.

### DETAILED DESCRIPTION

“OBS” refers to on-board diagnostic system provide access to the status of the various vehicle subsystems. implementations use a standardized digital communications port to provide real-time data in addition to a standardized series of diagnostic trouble codes, or DTCs, which allow one to rapidly identify and remedy malfunctions within the vehicle

“Hyperbolic tangent function” refers to a function of the form tan h(x)=sin h(x)/cos h(x). The tan h function is a popular activation function in artificial neural networks. Like the sigmoid, the tan h function is also sigmoidal (“s”-shaped), but instead outputs values that range (−1, 1). Thus, strongly negative inputs to the tan h will map to negative outputs. Additionally, only zero-valued inputs are mapped to near-zero outputs. These properties make the network less likely to get “stuck” during training.

“ReLU” refers to a rectifier function, an activation function defined as the positive part of its input. It is also known as a ramp function and is analogous to half-wave rectification in electrical signal theory. ReLu is a popular activation function in deep neural networks.

“Backpropagation” refers to an algorithm used in artificial neural networks to calculate a gradient that is needed in the calculation of the weights to be used in the network. It is commonly used to train deep neural networks, a term referring to neural networks with more than one hidden layer. For backpropagation, the loss function calculates the difference between the network output and its expected output, after a case propagates through the network.

“Loss function” refers to also referred to as the cost function or error function (not to be confused with the Gauss error function), is a function that maps values of one or more variables onto a real number intuitively representing some “cost” associated with those values.

“Softmax function” refers to a function of the form f(xi)=exp(xi)/sum(exp(x)) where the sum is taken over a set of x. Softmax is used at different layers (often at the output layer) of artificial neural networks to predict classifications for inputs to those layers. The softmax function calculates the probabilities distribution of the event xi over ‘n’ different events. In general sense, this function calculates the probabilities of each target class over all possible target classes. The calculated probabilities are helpful for predicting that the target class is represented in the inputs. The main advantage of using Softmax is the output probabilities range. The range will 0 to 1, and the sum of all the probabilities will be equal to one. If the softmax function used for multi-classification model it returns the probabilities of each class and the target class will have the high probability. The formula computes the exponential (e-power) of the given input value and the sum of exponential values of all the values in the inputs. Then the ratio of the exponential of the input value and the sum of exponential values is the output of the softmax function.

“Sigmoid function” refers to a function of the form f(x)=1/(exp(−x)). The signmoid function is used as an activation function in artificial neural networks. It has the property of mapping a wide range of input values to the range 0-1, or sometimes −1 to 1.

“Parser” refers to logic that divides an amalgamated input sequence or structure into multiple individual elements. Example hardware parsers are packet header parsers in network routers and switches. An example software or firmware parser is: aFields=split(“val1, val2, val3”, “,”); Another example of a software or firmware parser is: readFromSensor gpsCoordinate; x_pos=gpsCoordinate.x; y_pos=gpsCoordinate.y; z_pos=gpsCoordinate.z; Other examples of parsers will be readily apparent to those of skill in the art, without undo experimentation.

“Orchestration engine” refers to logic to generate action signals to define operational behavior of a device from event signals received from another system component. An example of a software orchestration engine is: IF(input=eventSignal1) output actionSignal1

“Engine” refers to logic or collection of logic modules working together to perform fixed operations on a set of inputs to generate a defined output. For example, IF (engine.logic {get.data( ),process.data( ),store.data( )} get.data(input1)->data.input1; process.data(data.input1)->formatted.data1->store.data(formatted.data1). A characteristic of some logic engines is the use of metadata that provides models of the real data that the engine processes. logic modules pass data to the engine, and the engine uses its metadata models to transform the data into a different state.

“Rule set” refers to configurable control logic or machine control logic.

The system and method allow for the extension of machine learning systems onto edge devices. The system receives machine state models and generates a set of minified rules that may be applied on a more memory and storage limited device. For example, a fleet vehicle may transmit telematics to a centralized fleet management system which constructs models of vehicles based on the transmitted data. This data model would likely contain a great deal of information, which, while relevant to the avoidance, prediction, and remediation of vehicle wear is also voluminous, precluding its direct storage and use on an individual fleet vehicle. The system and method allow for the extraction of relevant information from that machine state model, and the generation of a minified set of rules which may then be used on the edge device, in this example, a vehicle computer or smart device.

A method for extending machine learning to edge devices involves generating a machine state model for at least one machine system from device data comprising diagnostic parameter values received from at least one edge device, through operation of a state machine modeler. The method applies the machine state model to a rule compactor to construct a rule set. The operation of the rule compactor involves extracting a plurality of machine states, transitions, transition probabilities, and state values associated with each of the machine states from the machine state model. The operation of the rule compactor also involves configuring a remediation parser with the state values to extract available remedial transitions for each of the machine states from the transitions based on the values of the state value for a starting state relative to an ending state. The operation of the rule compactor also involves ranking the remedial transitions based on the transition probabilities associated with the remedial transition. The operation of the rule compactor then generates the rule set to encode the activation of the remedial transitions in rank order based upon the machine state. The method then transmits the rule set to a communications engine client for transmission to the at least one edge device to update a rules engine on the at least one edge device for controlling the at least one edge device.

In some configurations, the method of extending machine learning to edge devices involves operating a state extractor. The state extractor involves compares the machine states, the transitions, and the state values of the machine state model to historical device data. The state extractor identifies diagnostic parameters associated with the transitions and the state values of an absorptive negative machine state. The state extractor then configures the state machine modeler with identified diagnostic parameters to generate a modified machine state model.

In some configurations, the historical device data is from an individual machine system.

In some configurations, the historical device data is for a subset of similar machine systems.

In some configurations, the state machine modeler utilizes an ensemble model.

In some configurations, the rule set further comprises a set of triggers based on a machine's possible states, the amount of time spent in those states, and the transitions between states.

In some configurations, the remedial transition is the transition applied in a direction opposite from the transition's original direction.

In some configurations, the rule set further comprises a set of triggers based on a machine's possible states, the amount of time spent in those states, and the transitions between states.

In some configurations, the remedial transition further comprises an action which may be implemented to force a machine to transition to a more positive state.

A non-transitory computer-readable storage medium, the computer-readable storage medium including instructions that when executed by a computer, cause the computer to generate a machine state model for at least one machine system from device data comprising diagnostic parameter values received from at least one edge device, through operation of a state machine modeler. The instructions may also cause the computer to apply the machine state model to a rule compactor to construct a rule set. The rule compactor may then extract a plurality of machine states, transitions, transition probabilities, and state values associated with each of the machine states from the machine state model. The rule compactor may then configure a remediation parser with the state values to extract available remedial transitions for each of the machine states from the transitions based on the values of the state value for a starting state relative to an ending state. The rule compactor may then rank the remedial transitions based on the transition probabilities associated with the remedial transition. The rule compactor may then generate the rule set to encode the activation of the remedial transitions in rank order based upon the machine state. The computer may then transmit the rule set to a communications engine client for transmission to the at least one edge device to update a rules engine on the at least one edge device for controlling the at least one edge device.

In some configurations, the instructions further configure the computer to operate a state extractor. The machine statestate extractor may then compare the machine states, the transitions, and the state values of the machine state model to historical device data. The machine statestate extractor may then identify diagnostic parameters associated with the transitions and the state values of an absorptive negative machine state. The machine statestate extractor may then configure the state machine modeler with identified diagnostic parameters to generate a modified machine state model.

In some configurations, the historical device data is for an individual machine system.

In some configurations, the historical device data is for a subset of similar machine systems.

In some configurations, the state machine modeler utilizes an ensemble model.

In some configurations, the rule set further comprises a set of triggers based on a machine system's possible states, the amount of time spent in those states, and the transitions between states.

In some configurations, the remedial transition is the transition applied in a direction opposite from the transition's original direction.

In some configurations, the rule set further comprises a set of triggers based on a machine's possible states, the amount of time spent in those states and the transitions between states.

In some configurations, the remedial transition further comprises an action which may be implemented to force a machine to transition to a more positive state.

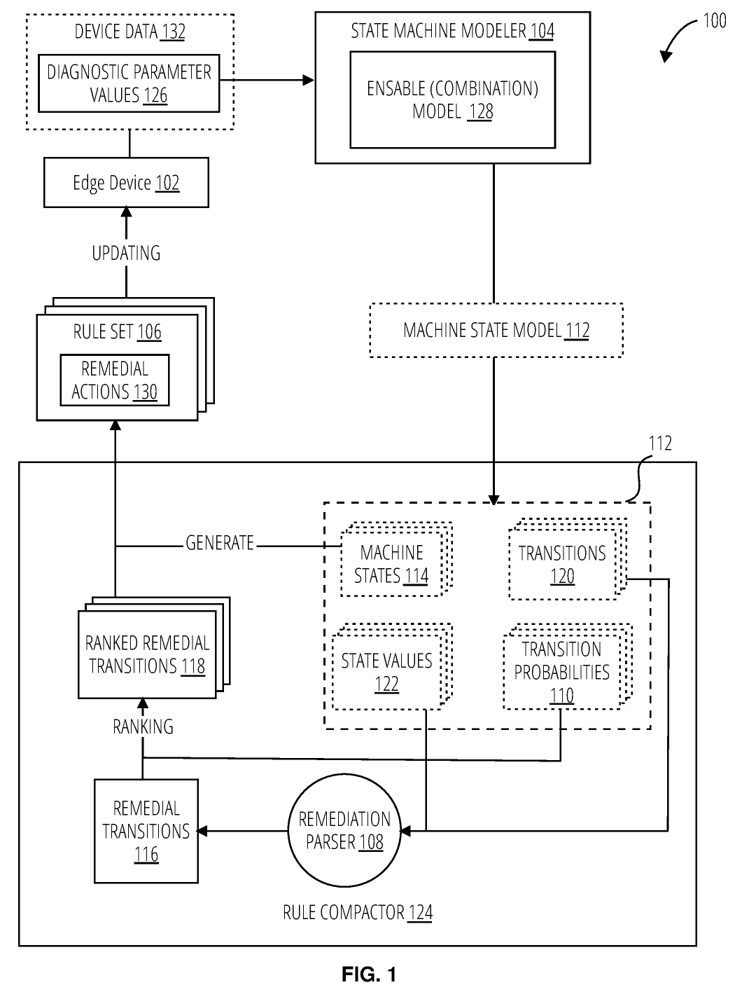

FIG. 1 illustrates an embodiment of a system for extending machine learning to edge devices 100.

The system for extending machine learning to edge devices 100 comprises an edge device 102, a state machine modeler 104 comprising an ensemble model 128, and a rule compactor 124. The state machine modeler 104 generates a machine state model 112 from on-board diagnostic system diagnostic parameter values 126 in the device data 132 received from the edge device 102. The machine state model 112 comprises machine states 114, transitions 120, a state values 122, and transition probabilities 110. The machine state model 112 is communicated to the rule compactor 124 to generate rule set 106 comprising remedial actions 130 for communication to the edge device 102. The rule compactor 124 comprises a remediation parser 108. The remediation parser 108 may be configured with the state values 122 to extract the remedial transitions 116 from the transitions 120. The rule compactor 124 generates the rule set 106 from the machine states 114 and the ranked remedial transitions 118. The rule set 106 is communicated to the edge device 102. The rule set 106 is then loaded on to the edge device 102.

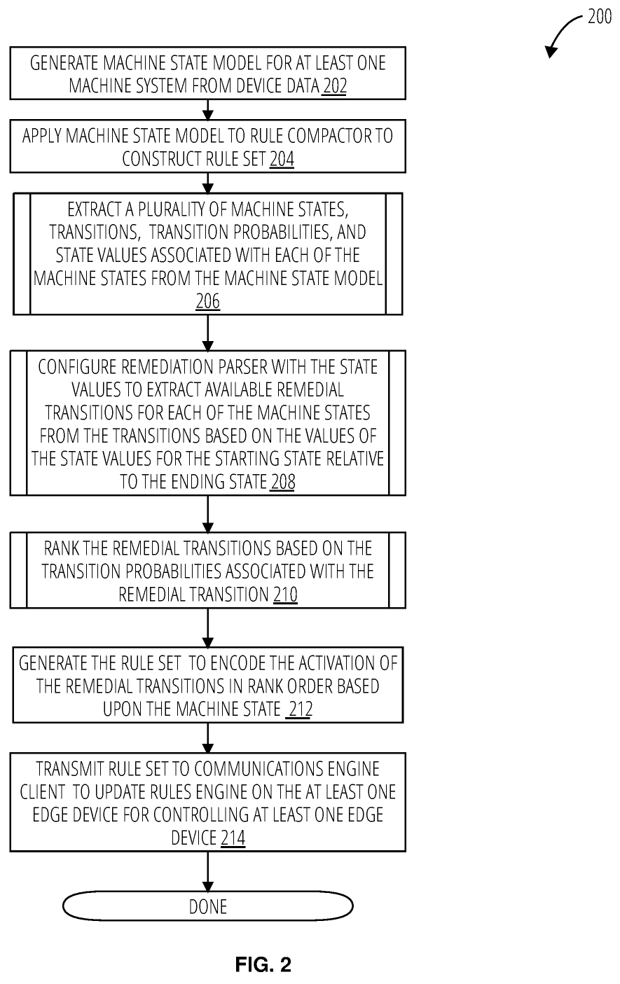

The system for extending machine learning to edge devices 100 may be operated in accordance with the process outlined in FIG. 2.

Referring to FIG. 2, the process for extending machine learning to edge devices 200 generates a machine state model for at least one machine system from device data comprising diagnostic parameter values received from at least one edge device, through operation of a state machine modeler (block 202). The machine state model is applied to a rule compactor to construct a rule set (block 204). A plurality of machine states, transitions, transition probabilities, and state values associated with each of the machine states are extracted from the machine state model (subroutine block 206). A remediation parser is configured with the state values to extract available remedial transitions for each of the machine states from the transitions based on the values of the state value for the starting state relative to the ending state (subroutine block 208). Remedial transitions are ranked based on the transition probabilities associated with the remedial transition (subroutine block 210). A rule set generated to encode the activation of the remedial transitions in rank order based upon the machine state that the (block 212). The rule set is transmitted to a communications engine client to update a rules engine on the at least one edge device for controlling the at least one edge device (block 214).

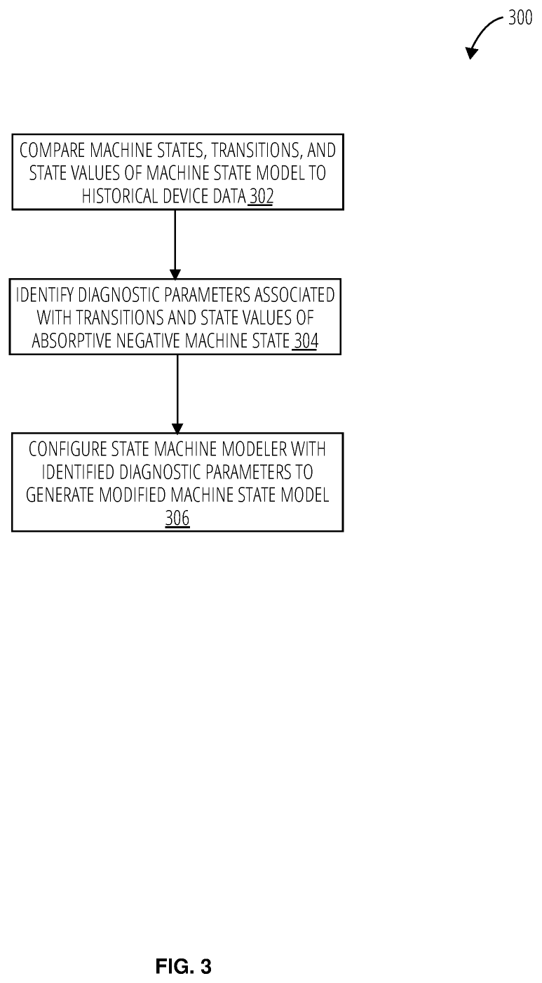

Referencing FIG. 3, a method 300 for operating a state extractor involves comparing the machine states, the transitions, and the state values of the machine state model to historical device data (block 302). In block 304, the method 300 identifies diagnostic parameters associated with the transitions and the state values of an absorptive negative machine state. In block 306, the method 300 configures the state machine modeler with identified diagnostic parameters to generate a modified machine state model.

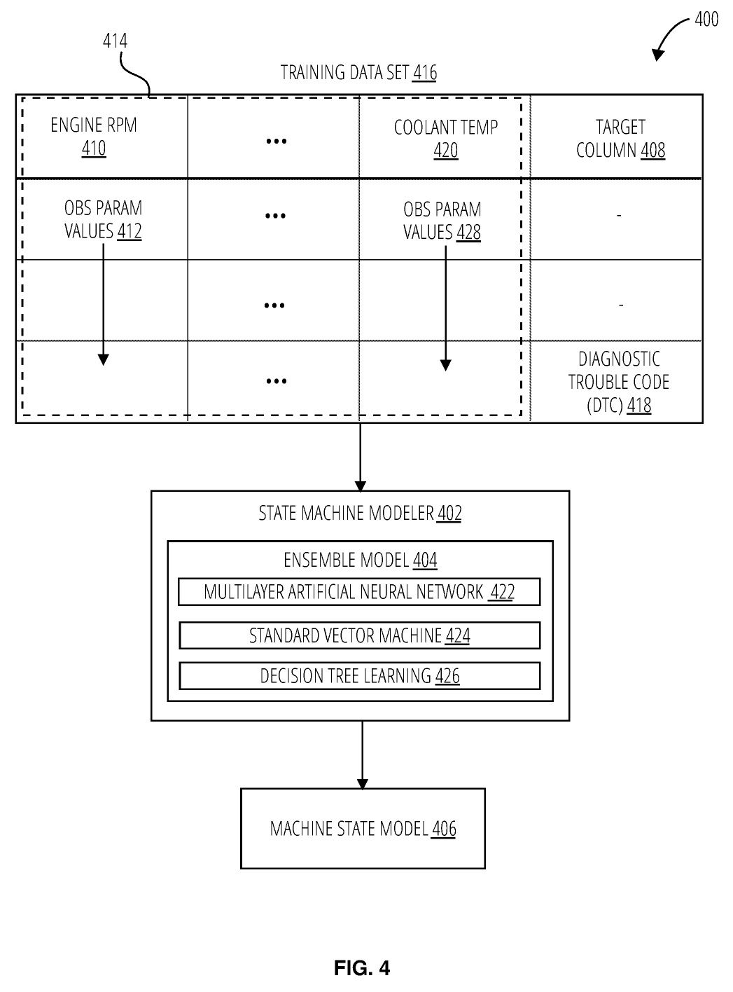

Referencing FIG. 4, a system 400 illustrates a training mode for the system for extending machine learning to edge devices. The system 400 includes training data set 416 that is provided to the state machine modeler 402, to generate the machine state model 406. The training data set 416 may comprise a file configured in columns (e.g., .csv) that includes various feature columns 414 each corresponding to a different parameter collected by the edge device. These parameters may be collected from a on-board diagnostic system (OBS) that is integrated with and/or in communication with the edge device. These parameters may be arranged in columns reporting an OBS parameter value per entry. For example, OBS parameter column may correspond to engine RPM 410 reporting OBS parameter values 412, while another column corresponds to coolant temp 420 reporting OBS parameter values 428. The training data set 416 includes a target column 408 that is monitored by the state machine modeler 402 to determine a failed machine state. The target column 408 reports diagnostic trouble code (DTC) 418 that indicates a negative state or an absorptive negative state of the device. The state machine modeler 402 utilizes the target column 408 in view of the feature columns 414 to generate the machine state model 406. The training data may also include reporting data before and after the appearance of the diagnostic trouble code (DTC) 418 as remediation actions may be identified based on changes in the feature columns 414.

In some configurations, the training data have an 80/20 validation rate to help train the state machine modeler 402. The state machine modeler 402 may receive a plurality training data sets to generate the machine state model 406.

In some configurations the state machine modeler 402 utilizes an ensemble model 404 that may include a multilayer artificial neural network 422, a standard vector machine 424, and decision tree learning 426 to generate a machine state model 406.

In statistics and machine learning, ensemble methods use multiple learning algorithms to obtain better predictive performance than could be obtained from any of the constituent learning algorithms alone. Unlike a statistical ensemble in statistical mechanics, which is usually infinite, a machine learning ensemble consists of only a concrete finite set of alternative models, but typically allows for a much more flexible structure to exist among those alternatives.

Supervised learning algorithms are most commonly described as performing the task of searching through a hypothesis space to find a suitable hypothesis that will make good predictions with a particular problem. Even if the hypothesis space contains hypotheses that are very well-suited for a particular problem, it may be very difficult to find a good one. Ensembles combine multiple hypotheses to form a (hopefully) better hypothesis. The term ensemble is usually reserved for methods that generate multiple hypotheses using the same base learner. The broader term of multiple classifier systems also covers hybridization of hypotheses that are not induced by the same base learner.

Evaluating the prediction of an ensemble typically requires more computation than evaluating the prediction of a single model, so ensembles may be thought of as a way to compensate for poor learning algorithms by performing a lot of extra computation. Fast algorithms such as decision trees are commonly used in ensemble methods (for example, random forests), although slower algorithms can benefit from ensemble techniques as well.

By analogy, ensemble techniques have been used also in unsupervised learning scenarios, for example in consensus clustering or in anomaly detection.

An ensemble is itself a supervised learning algorithm, because it can be trained and then used to make predictions. The trained ensemble, therefore, represents a single hypothesis. This hypothesis, however, is not necessarily contained within the hypothesis space of the models from which it is built. Thus, ensembles can be shown to have more flexibility in the functions they can represent. This flexibility can, in theory, enable them to over-fit the training data more than a single model would, but in practice, some ensemble techniques (especially bagging) tend to reduce problems related to over-fitting of the training data.

Empirically, ensembles tend to yield better results when there is a significant diversity among the models. Many ensemble methods, therefore, seek to promote diversity among the models they combine. Although perhaps non-intuitive, more random algorithms (like random decision trees) can be used to produce a stronger ensemble than very deliberate algorithms (like entropy-reducing decision trees). Using a variety of strong learning algorithms, however, has been shown to be more effective than using techniques that attempt to dumb-down the models in order to promote diversity.

Common Types of Ensembles

The Bayes Optimal Classifier is a classification technique. It is an ensemble of all the hypotheses in the hypothesis space. On average, no other ensemble can outperform it. Naïve Bayes Optimal Classifier is a version of this that assumes that the data is conditionally independent on the class and makes the computation more feasible. Each hypothesis is given a vote proportional to the likelihood that the training dataset would be sampled from a system if that hypothesis were true. To facilitate training data of finite size, the vote of each hypothesis is also multiplied by the prior probability of that hypothesis. The Bayes Optimal Classifier can be expressed with the following equation:

$$y = {argmax}_{{c}_{j} ∈ C} {\sum }_{{h}_{i} ∈ H} P ( {c}_{j} \vert {h}_{i} ) P ( {h}_{i} \vert T ) \qquad Equation 1$$

where y is the predicted class, C is the set of all possible classes, H is the hypothesis space, P refers to a probability, and T is the training data. As an ensemble, the Bayes Optimal Classifier represents a hypothesis that is not necessarily in H. The hypothesis represented by the Bayes Optimal Classifier, however, is the optimal hypothesis in ensemble space (the space of all possible ensembles consisting only of hypotheses in H).

This formula can be restated using Bayes' theorem, which says that the posterior is proportional to the likelihood times the prior:

P(hᵢ|T)∝P(T|hᵢ)P(hᵢ) Equation 2

Hence,

$$y = {argmax}_{{c}_{j} ∈ C} {\sum }_{{h}_{i} ∈ H} P ( {c}_{j} \vert {h}_{i} ) P ( T \vert {h}_{i} ) P ( {h}_{i} ) \qquad Equation 3$$

Bootstrap Aggregating

Bootstrap aggregating, often abbreviated as bagging, involves having each model in the ensemble vote with equal weight. In order to promote model variance, bagging trains each model in the ensemble using a randomly drawn subset of the training set. As an example, the random forest algorithm combines random decision trees with bagging to achieve very high classification accuracy.

Boosting

Boosting involves incrementally building an ensemble by training each new model instance to emphasize the training instances that previous models mis-classified. In some cases, boosting has been shown to yield better accuracy than bagging, but it also tends to be more likely to over-fit the training data. By far, the most common implementation of boosting is Adaboost, although some newer algorithms are reported to achieve better results.

Bayesian Parameter Averaging

Bayesian parameter averaging (BPA) is an ensemble technique that seeks to approximate the Bayes Optimal Classifier by sampling hypotheses from the hypothesis space, and combining them using Bayes' law. Unlike the Bayes optimal classifier, Bayesian model averaging (BMA) can be practically implemented. Hypotheses are typically sampled using a Monte Carlo sampling technique such as MCMC. For example, Gibbs sampling may be used to draw hypotheses that are representative of the distribution P(TIH). It has been shown that under certain circumstances, when hypotheses are drawn in this manner and averaged according to Bayes' law, this technique has an expected error that is bounded to be at most twice the expected error of the Bayes optimal classifier. Despite the theoretical correctness of this technique, early work showed experimental results suggesting that the method promoted over-fitting and performed worse compared to simpler ensemble techniques such as bagging; however, these conclusions appear to be based on a misunderstanding of the purpose of Bayesian model averaging vs. model combination. Additionally, there have been considerable advances in theory and practice of BMA. Recent rigorous proofs demonstrate the accuracy of BMA in variable selection and estimation in high-dimensional settings, and provide empirical evidence highlighting the role of sparsity-enforcing priors within the BMA in alleviating overfitting.

Bayesian Model Combination

Bayesian model combination (BMC) is an algorithmic correction to Bayesian model averaging (BMA). Instead of sampling each model in the ensemble individually, it samples from the space of possible ensembles (with model weightings drawn randomly from a Dirichlet distribution having uniform parameters). This modification overcomes the tendency of BMA to converge toward giving all of the weight to a single model. Although BMC is somewhat more computationally expensive than BMA, it tends to yield dramatically better results. The results from BMC have been shown to be better on average (with statistical significance) than BMA, and bagging.

The use of Bayes' law to compute model weights necessitates computing the probability of the data given each model. Typically, none of the models in the ensemble are exactly the distribution from which the training data were generated, so all of them correctly receive a value close to zero for this term. This would work well if the ensemble were big enough to sample the entire model-space, but such is rarely possible. Consequently, each pattern in the training data will cause the ensemble weight to shift toward the model in the ensemble that is closest to the distribution of the training data. It essentially reduces to an unnecessarily complex method for doing model selection.

The possible weightings for an ensemble can be visualized as lying on a simplex. At each vertex of the simplex, all of the weight is given to a single model in the ensemble. BMA converges toward the vertex that is closest to the distribution of the training data. By contrast, BMC converges toward the point where this distribution projects onto the simplex. In other words, instead of selecting the one model that is closest to the generating distribution, it seeks the combination of models that is closest to the generating distribution.

The results from BMA can often be approximated by using cross-validation to select the best model from a bucket of models. Likewise, the results from BMC may be approximated by using cross-validation to select the best ensemble combination from a random sampling of possible weightings.

Bucket of Models

A “bucket of models” is an ensemble technique in which a model selection algorithm is used to choose the best model for each problem. When tested with only one problem, a bucket of models can produce no better results than the best model in the set, but when evaluated across many problems, it will typically produce much better results, on average, than any model in the set.

Cross-Validation Selection can be summed up as: try them all with the training set, and pick the one that works best.

Gating is a generalization of Cross-Validation Selection. It involves training another learning model to decide which of the models in the bucket is best-suited to solve the problem. Often, a perceptron is used for the gating model. It can be used to pick the “best” model, or it can be used to give a linear weight to the predictions from each model in the bucket.

When a bucket of models is used with a large set of problems, it may be desirable to avoid training some of the models that take a long time to train. Landmark learning is a meta-learning approach that seeks to solve this problem. It involves training only the fast (but imprecise) algorithms in the bucket, and then using the performance of these algorithms to help determine which slow (but accurate) algorithm is most likely to do best.

Stacking

Stacking (sometimes called stacked generalization) involves training a learning algorithm to combine the predictions of several other learning algorithms. First, all of the other algorithms are trained using the available data, then a combiner algorithm is trained to make a final prediction using all the predictions of the other algorithms as additional inputs. If an arbitrary combiner algorithm is used, then stacking can theoretically represent any of the ensemble techniques described in this article, although, in practice, a logistic regression model is often used as the combiner.

Stacking typically yields performance better than any single one of the trained models. It has been successfully used on both supervised learning tasks (regression, classification and distance learning) and unsupervised learning (density estimation). It has also been used to estimate bagging's error rate. It has been reported to out-perform Bayesian model-averaging.

In some configurations, the ensemble model 404 may incorporate a standard vector machine 424 system to generate the machine state model 406. In machine learning, support-vector machines (SVMs, also support-vector networks) are supervised learning models with associated learning algorithms that analyze data used for classification and regression analysis. Given a set of training examples, each marked as belonging to one or the other of two categories, an SVM training algorithm builds a model that assigns new examples to one category or the other, making it a non-probabilistic binary linear classifier (although methods such as Platt scaling exist to use SVM in a probabilistic classification setting). An SVM model is a representation of the examples as points in space, mapped so that the examples of the separate categories are divided by a clear gap that is as wide as possible. New examples are then mapped into that same space and predicted to belong to a category based on which side of the gap they fall.

In addition to performing linear classification, SVMs can efficiently perform a non-linear classification using what is called the kernel trick, implicitly mapping their inputs into high-dimensional feature spaces.

When data is unlabeled, supervised learning is not possible, and an unsupervised learning approach may be required, which attempts to find natural clustering of the data to groups, and then map new data to these formed groups.

Classifying data is a common task in machine learning. In the case of support-vector machines, a data point is viewed as a p-dimensional vector (a list of p numbers), and where a determination is made on whether such points with a (p-1)-dimensional hyperplane can be separated. This is called a linear classifier. There are many hyperplanes that might classify the data. One reasonable choice as the best hyperplane is the one that represents the largest separation, or margin, between the two classes. The hyperplane is chosen so that the distance from it to the nearest data point on each side is maximized.

More formally, a support-vector machine constructs a hyperplane or set of hyperplanes in a high- or infinite-dimensional space, which can be used for classification, regression, or other tasks like outliers detection. Intuitively, a good separation is achieved by the hyperplane that has the largest distance to the nearest training-data point of any class (so-called functional margin), since in general the larger the margin, the lower the generalization error of the classifier.

Whereas the original problem may be stated in a finite-dimensional space, it often happens that the sets to discriminate are not linearly separable in that space. In some configurations, the original finite-dimensional space may be mapped into a much higher-dimensional space, presumably making the separation easier in that space. To keep the computational load reasonable, the mappings used by SVM schemes are designed to ensure that dot products of pairs input data vectors may be computed easily in terms of the variables in the original space, by defining them in terms of a kernel function k(x,y) selected to suit the problem. The hyperplanes in the higher-dimensional space are defined as the set of points whose dot product with a vector in that space is constant, where such a set of vectors is an orthogonal (and thus minimal) set of vectors that defines a hyperplane. The vectors defining the hyperplanes can be chosen to be linear combinations with parameters a, of images of feature vectors x, that occur in the data base. With this choice of a hyperplane, the points x in the feature space that are mapped into the hyperplane are defined by the relation

Σ_{z}αᵢk(xᵢ,x)=constant Equation 4

Note that if k(x,y) becomes small as y grows further away from x, each term in the sum measures the degree of closeness of the test point x to the corresponding data base point xᵢ. In this way, the sum of kernels above can be used to measure the relative nearness of each test point to the data points originating in one or the other of the sets to be discriminated. Note the fact that the set of points x mapped into any hyperplane can be quite convoluted as a result, allowing much more complex discrimination between sets that are not convex at all in the original space.

In some configurations, the ensemble model 404 may utilize decision tree learning 426 to generate the machine state model 406.

Decision tree learning uses a decision tree (as a predictive model) to go from observations about an item (represented in the branches) to conclusions about the item's target value (represented in the leaves). It is one of the predictive modeling approaches used in statistics, data mining and machine learning. Tree models where the target variable can take a discrete set of values are called classification trees. In these tree structures, leaves represent class labels and branches represent conjunctions of features that lead to those class labels. Decision trees where the target variable can take continuous values (typically real numbers) are called regression trees.

In decision analysis, a decision tree can be used to visually and explicitly represent decisions and decision making. In data mining, a decision tree describes data (but the resulting classification tree can be an input for decision making). This page deals with decision trees in data mining.

Decision tree learning is a method commonly used in data mining. The goal is to create a model that predicts the value of a target variable based on several input variables. Each interior node corresponds to one of the input variables; there are edges to children for each of the possible values of that input variable. Each leaf represents a value of the target variable given the values of the input variables represented by the path from the root to the leaf.

A decision tree is a simple representation for classifying examples. For this section, assume that all of the input features have finite discrete domains, and there is a single target feature called the “classification”. Each element of the domain of the classification is called a class. A decision tree or a classification tree is a tree in which each internal (non-leaf) node is labeled with an input feature. The arcs coming from a node labeled with an input feature are labeled with each of the possible values of the target or output feature or the arc leads to a subordinate decision node on a different input feature. Each leaf of the tree may be labeled with a class or a probability distribution over the classes.

A tree can be “learned” by splitting the source set into subsets based on an attribute value test. This process is repeated on each derived subset in a recursive manner called recursive partitioning. The recursion is completed when the subset at a node has all the same value of the target variable, or when splitting no longer adds value to the predictions. This process of top-down induction of decision trees (TDIDT) is an example of a greedy algorithm, and it is by far the most common strategy for learning decision trees from data.

In data mining, decision trees can be described also as the combination of mathematical and computational techniques to aid the description, categorization and generalization of a given set of data. Data comes in records of the form: (x,Y)=(xi, x₂, x₃, . . . , xₖ, Y)

The dependent variable, Y, is the target variable that we are trying to understand, classify or generalize. The vector x is composed of the features, x1, x2, x3 etc., that are used for that task.

Types of Decision Trees Decision trees used in data mining are of two main types:
Classification tree analysis is when the predicted outcome is the class (discrete) to which the data belongs.
Regression tree analysis is when the predicted outcome can be considered a real number (e.g. the price of a house, or a patient's length of stay in a hospital).

The term Classification And Regression Tree (CART) analysis is an umbrella term used to refer to both of the above procedures, first introduced by Breiman et al. in 1984. Trees used for regression and trees used for classification have some similarities—but also some differences, such as the procedure used to determine where to split.

Some techniques, often called ensemble methods, construct more than one decision tree:
Boosted trees Incrementally building an ensemble by training each new instance to emphasize the training instances previously mis-modeled. A typical example is AdaBoost. These can be used for regression-type and classification-type problems.
Bootstrap aggregated (or bagged) decision trees, an early ensemble method, builds multiple decision trees by repeatedly resampling training data with replacement, and voting the trees for a consensus prediction.
A random forest classifier is a specific type of bootstrap aggregating
Rotation forest—in which every decision tree is trained by first applying principal component analysis (PCA) on a random subset of the input features.

A special case of a decision tree is a decision list, which is a one-sided decision tree, so that every internal node has exactly 1 leaf node and exactly 1 internal node as a child (except for the bottommost node, whose only child is a single leaf node). While less expressive, decision lists are arguably easier to understand than general decision trees due to their added sparsity, permit non-greedy learning methods and monotonic constraints to be imposed.

Decision tree learning is the construction of a decision tree from class-labeled training tuples. A decision tree is a flow-chart-like structure, where each internal (non-leaf) node denotes a test on an attribute, each branch represents the outcome of a test, and each leaf (or terminal) node holds a class label. The topmost node in a tree is the root node.

There are many specific decision-tree algorithms. Notable ones include for example:
Iterative Dichotomiser 3 (ID3)
C4.5 Algorithm
Classification And Regression Tree (CART)
CHi-squared Automatic Interaction Detector (CHAID) is a decision tree technique, based on adjusted significance testing. CHAID performs multi-level splits when computing classification trees.
Multivariate adaptive regression splines (MARS) which is a non-parametric regression technique and can be seen as an extension of linear models that automatically models nonlinearities and interactions between variables.
Conditional Inference Trees which is a statistics-based approach that uses non-parametric tests as splitting criteria, corrected for multiple testing to avoid overfitting. This approach results in unbiased predictor selection and does not require pruning.

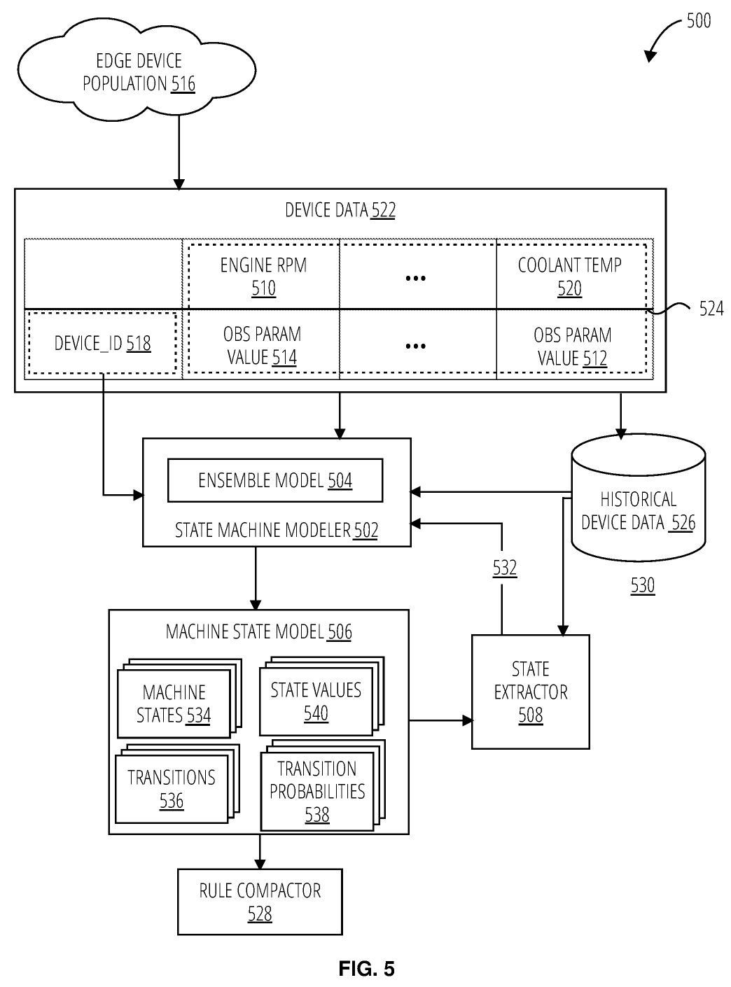

Referencing FIG. 5, a system 500 illustrates the communication of device data 522 from a plurality of edge devices 516 that make up a population of edge devices. The device data 522 comprises feature columns 524 similar to the training data sets but additionally includes a device_ID 518 that may correspond to each entry. For example, device data 522 may include an entry corresponding to a device_ID 518 comprising an OBS parameter value 514 for Engine RPM 510 and OBS parameter value 512 for coolant temp 520, as well as other monitored parameters. The device data 522 is utilized by the state machine modeler 502 comprising an ensemble model 504 to generate the machine state model 506. for the rule compactor 528. The machine state model 506 comprises machine states 534, state values 540, transitions 536, and transition probabilities 538.

In some configurations, the device data 522 from the plurality of edge devices 516 may be the same model with the same or similar configurations for the edge device or machine system. In the aforementioned configuration, the uniformity of the device models or configurations reduces variability in data that may affect accurate representations of a machine system and allows for a better representative machine state model 506 for generating the remedial actions.

In some configurations, the state machine modeler 502 may adjust the machine state model 506 based on historical device data 526 from an individual device. Device data 522 corresponding to a particular device_ID 518 may be communicated to a controlled memory data structure 530 and stored as a historical device data 526 to be utilized by the state machine modeler 502.

In some configurations, a state extractor 508 may be utilized by the system 500 to identify parameters and parameters values that precede a negative state of the device (e.g., neutral state, absorptive negative state). The state extractor 508 may identify a parameter, a set of parameters, and/or changes in the parameters or set of parameters that precede a known failure state (e.g., negative state) by comparing the machine state model 506 to historical device data 526 in the controlled memory data structure 530. The state extractor 508 may communicate the identified diagnostic parameters 532 to the state machine modeler 502 to improve the machine state model 506.

One of skill in the art will realize that the methods and apparatuses of this disclosure describe proscribed functionality associated with a machine system operation. Specifically, the methods and apparatuses, inter alia, are directed to system that generates a machine state model for a machine system for determining remediation actions that are applied to the machine system to transition the system to a different state of operation. One of skill in the art will realize that these methods are significantly more than abstract data collection and manipulation.

Further, the methods provide a technological solution to a technological problem, and do not merely state the outcome or results of the solution. As an example, an edge device communicates information about a machine system that is either in an operational state or a fail state, the invention generates a machine state model to identify intermediary states and transition actions for those states. This allows a rule compactor to utilize the machine state model and the transition actions to generate a rule set with remedial actions to be loaded on the edge device to implement, preventing the machine system from going into the fail state or transitioning the machine system out of the fail state into a more favorable state (e.g., positive state, operational state, etc.). This is a particular technological solution producing a technological and tangible result. The methods are directed to a specific technique that improves the relevant technology and are not merely a result or effect.

Additionally, the methods produce the useful, concrete, and tangible result of remediating a machine state, thereby identifying each change as associated with its antecedent rule set.

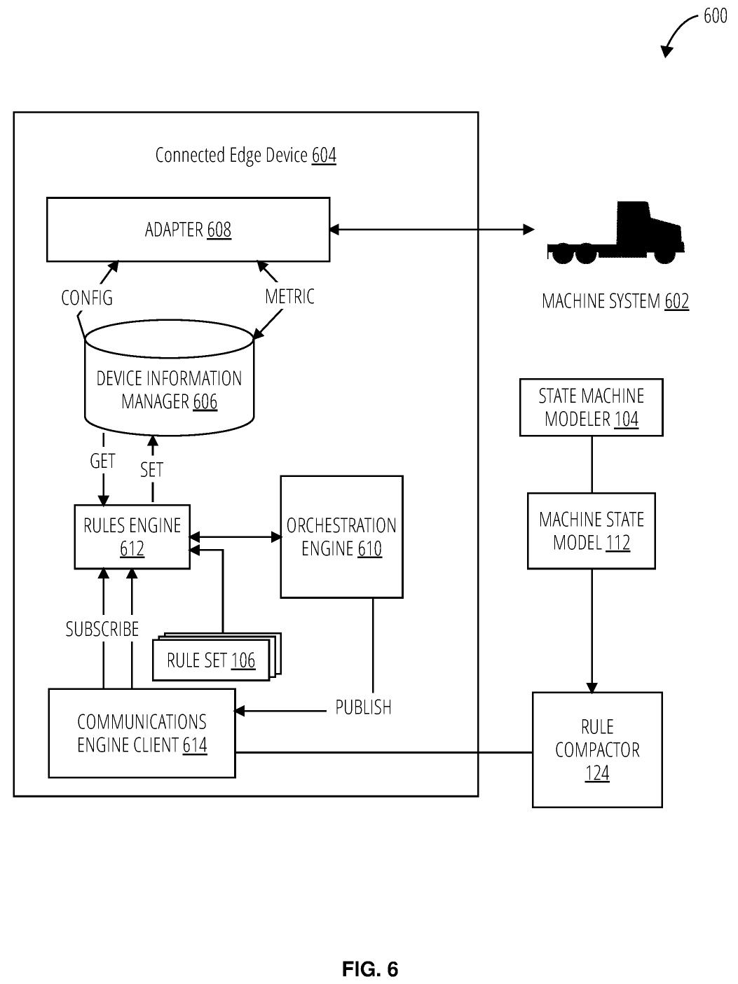

FIG. 6 illustrates an embodiment of a system for extending machine learning to edge devices 600.

The rule compactor 124 receives the machine state model 112 from the state machine modeler 104. The rule compactor 124 transmits the rule set 106 to the communications engine client 614. The connected edge device 604 utilizes the rules engine 612 to subscribe to the communications engine client 614 and receives the rule set 106. The connected edge device 604 may store the rule set 106 within the device information manager 606 and the connected edge device 604 may utilize the adapter 608 to communicate with the machine system 602. When a rule set 106 is received from the rule compactor 124, the rule set 106 may be utilzied to update the rules engine 612, reconfiguring the control code of the connected edge device 604. The modification of the control code may be set in the device information manager 606 which may be further utilized to communicate operational changes to the machine system 602 by way of the adapter 608.

The system for extending machine learning to edge devices 600 comprises a rule set 106, a machine state model 112, a machine system 602, a connected edge device 604, a device information manager 606, an adapter 608, a rule compactor 124, a rules engine 612, an orchestration engine 610, a communications engine client 614, and a state machine modeler 104. An embedded system may be connected to a larger system through a hardware adapter 608, the hardware adapter receives signals utilizing a protocol, for example SPI or I²C, a legacy connection driver may be implemented in software which is downloaded and loaded automatically onto the connected edge device 604.

The system for extending machine learning to edge devices 600 may be operated in accordance with the process outlined in FIG. 2.

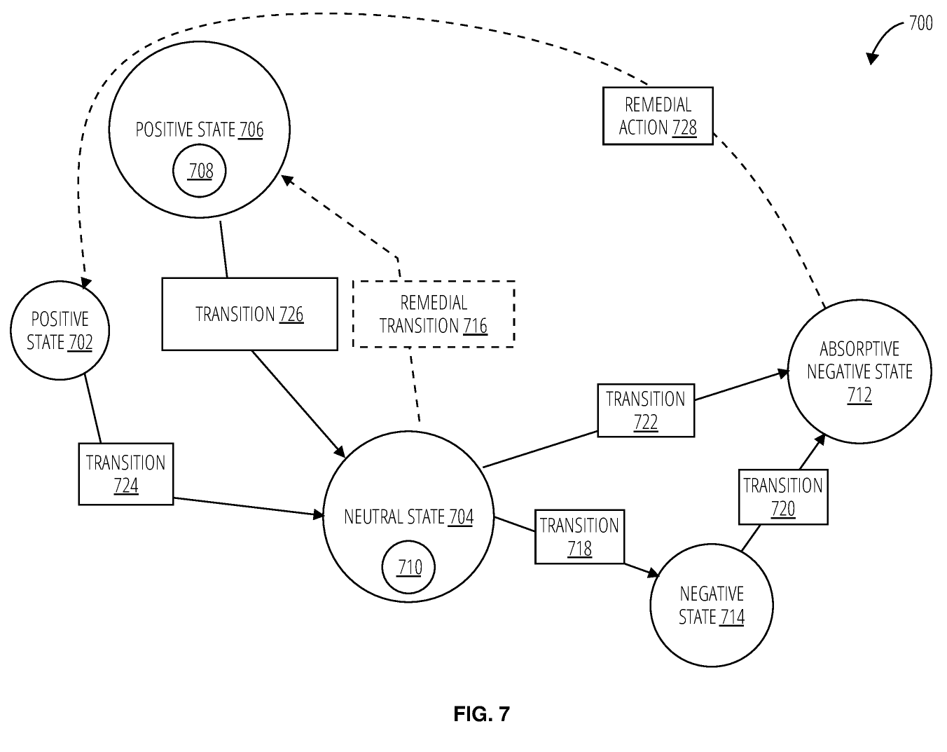

FIG. 7 illustrates an embodiment of a finite state machine 700. The finite state machine 700 comprises a positive state 702, a neutral state 704, a positive state 706, a state values 708, a state values 710, an absorptive negative state 712, a negative state 714, a remedial transition 716, a transition 718, a transition 720, a transition 722, a transition 724, a transition 726, and a remedial action 728.

The positive state 702 transitions to the neutral state 704 via transition 724. The positive state 706 transitions to the neutral state 704 via the transition 726. The neutral state 704 transitions to the positive state 706 via the remedial transition 716. The neutral state 704 transitions to the negative state 714 via the transition 718. The negative state 714 transitions to the absorptive negative state 712 via the transition 720. The neutral state 704 transitions to the absorptive negative state 712 via the transition 722. The absorptive negative state 712 transitions to the positive state 702 if remedial action 728 is applied.

All systems will invariably experience entropic decay, so if left to run unmonitored, the system modeled by the finite state machine 700 will naturally move from more positive states to more negative states. The transitions (transition 726, transition 724, transition 718, transition 722, and transition 720) carry information about the probability of transitioning from a more positive state to a more negative state, as well as the amount of time spent in the states. Transition data may be applied in reverse in order to determine the most likely remedial action needed to transition from a more negative state to a more positive state. For example, the positive state 706 transitions to the neutral state 704 via transition 726. The system may apply transition 726 in the reverse direction as remedial transition 716, to transition back to the positive state 706 from the remedial transition 716. The system may model an absorptive negative state 712 wherein an external remedial action 728 must be taken in order to move to a previous state. For example, an absorptive negative state 712 for an automobile may be that the engine seizes if there is too little oil, in which case the remedial action 728 that should be taken to revert the vehicle back to the positive state 702 would be to replace the engine.

The system may determine the transition direction by comparing the state values 708 and the state values 710. The state values 708 and the state values 710 may be ranked numerically, for example, the state values 710 and the state values 708 may be assigned values on a scale, or a qualitative measure may be applied and rank ordered. For example, a list with state names progressing from good/positive to bad/negative, or a color range with green being good/positive and red being bad/negative.

For modeling purposes, the number of states defined is finite, even if quite large. At this point, it seems clear that the states and transitions may be modeled as a directed graph, with the condition of state as nodes and transitions as edges. The precise definition of the state, and thus the information for any particular device's inclusion may be chosen at will, subject to certain constraints. Moreover, the definition of the transition path, and therefore the resulting connectivity of the graph, may also be formed of edges weighted for the desired utility of modeling. This graph may therefore model the lifecycle (or portion thereof) of a device. The state of the device is a node in a directed graph. The edges of this graph represent possible transition from one state to another. Depending on precisely how these nodes and edges are defined, then the graph can be modeled as a finite-state machine, a Markov chain, or a Bayesian network.

This figure illustrates a number of possibilities. There are several states, positive state 702, positive state 706, neutral state 704, negative state 714, and absorptive negative state 712. The starting state, at initialization time, is positive state 702. Considering only the solid paths for the moment, positive state 702 can only be exited, and absorptive negative state 712 can only be entered. This would then be an example of an absorbing Markov chain. Positive state 702 may thought of as a new device, and absorptive negative state 712 the completely failed device, with the other states as relevant intermediate steps. On one side of each edge is a rate, and on the other is a conditional probability. In the discrete time case, the probability of being in any given state depends only on the starting state and number of steps taken, and may be conveniently calculated using a state vector and transition matrix. In the continuous time case, the probability of being in a state at time t depends on the rate of transition and the probability functions. Thus the holding time, or amount of time (in a distribution sense) left to remain in a state, is dependent only on the rate of exit from the state, and is thus exponential. As with the discrete time case, several properties of interest can be determined though the transition matrix. There also are a number of different formulations of the continuous time Markov chain (CTMC), including cyclic versions where repairs are made (the dotted line), or explosive versions where new devices are inserted, but none leave, and so forth.

A Bayesian network, may work equally well with frequentist methods of calculating probabilities. In this case the set of states (or even events) may be modeled as a directed acyclic graph with nodes as the set of states, which should still have some of the properties of random variables as before, but are not strictly stochastic insomuch as there does not have to be an evolution though time for the changes in states. That is, the transition is governed only by conditional probabilities, and the exact state of the system does not depend on the time (or number of steps) but only of the probability function of each node which takes as an input the parent nodes leading into it, and outputs the probability (or probability distribution) of the variable or state represented by the node. If nodes are not connected, they are conditionally independent. Typically, the network may be considered to be a complete model for the states and relationships under investigation, and thus may be used to formulate answers to probability related existence questions about the states. Additionally, new information may be easily incorporated by updating the priors, and the overall network is normally considered to be a method with which to apply Bayes theorem to complex problems. There are also a number of machine learning techniques which may be used (with varying degrees of success) to determine the structure and probabilities of an undetermined or underdetermined Bayes network.

Discrete state space Markov chains, in particular discrete time, and continuous time Markov chains may be used. In the discreet time example, the system remains in a given state for exactly one unit of time before making a transition (or state change). In this case, the path though the graph relies only on the probability of taking each step from each state, and you can calculate the probability of being in any state given the starting state from which you would like to calculate, and the number of time steps take. The drunkard's walk is a well-known example of this type of Markov chain, and can be either open ended, or absorbing if there is a final state(s) from which there is no exit. It is perhaps more realistic to consider that case where the system can remain in a state for a continuous amount of time. Now the probability of being in any given state is governed by the probability of transition with respect to a rate of transition.

In some instances, the neutral state 704 may include parameters (state values 710) that may indicate a positive state or a negative state at a different time. The neutral state 704 may be characterized by a low confidence value associated with a state assignment such that at the given time when the state values where collected, the machine state was not classified as either being in the absorptive negative state 712, the positive state 706, or the negative state 714. Further monitoring of the neutral state 704 may provide further details as to the state of the device. In some instances, a remedial transition 716 may be applied pre-emptively to the neutral state 704 to return the machine to a positive state 706.

In some instances, the neutral state 704 moves into an absorptive negative state 712 or a negative state 714 that may be identified by transition 722 or a transition 718, respectively. Transitions are found in the rule set describing transition between different states identifiable by combinations of state values, and or changes in state values over time.

In some configurations, the absorptive negative state 712 may correspond to a set of states values or changes in state values that may indicate machine failure or that the machine has recently failed. When this occurs a remedial action 728 may be implemented by the edge device to transition the absorptive negative state 712 into the positive state 702.

A basic deep neural network 800 is based on a collection of connected units or nodes called artificial neurons which loosely model the neurons in a biological brain. Each connection, like the synapses in a biological brain, can transmit a signal from one artificial neuron to another. An artificial neuron that receives a signal can process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals travel from the first layer (the input layer 802), to the last layer (the output layer 806), possibly after traversing one or more intermediate layers, called hidden layers 804.

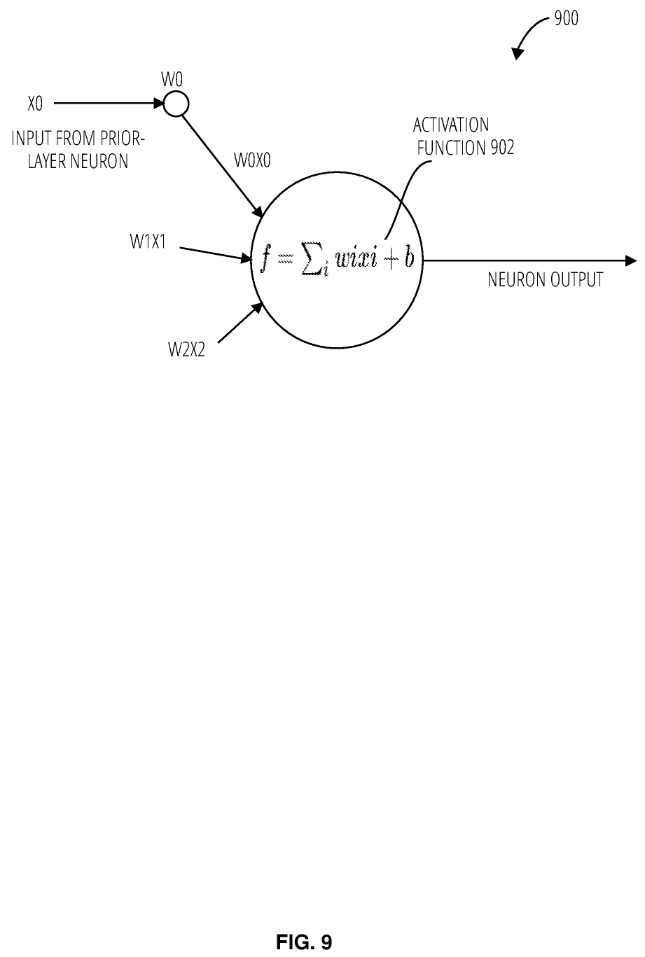

Referring to FIG. 9, an artificial neuron 900 receiving inputs from predecessor neurons consists of the following components:
inputs xᵢ;
weights w, applied to the inputs;
an optional threshold (b), which stays fixed unless changed by a learning function; and
an activation function 902 that computes the output from the previous neuron inputs and threshold, if any.

An input neuron has no predecessor but serves as input interface for the whole network. Similarly an output neuron has no successor and thus serves as output interface of the whole network.

The network includes connections, each connection transferring the output of a neuron in one layer to the input of a neuron in a next layer. Each connection carries an input x and is assigned a weight w.

The activation function 902 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

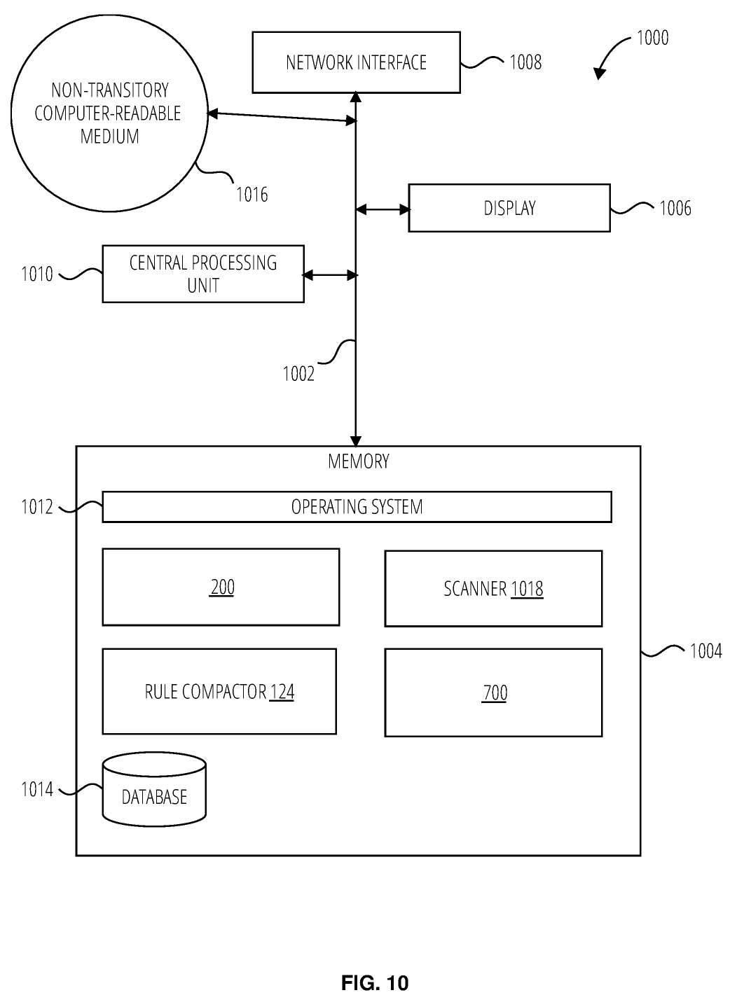

FIG. 10 illustrates several components of an exemplary system 1000 in accordance with one embodiment. In various embodiments, system 1000 may include a desktop PC, server, workstation, mobile phone, laptop, tablet, set-top box, appliance, or other computing device that is capable of performing operations such as those described herein. In some embodiments, system 1000 may include many more components than those shown in FIG. 10. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 1000 may comprise one or more physical and/or logical devices that collectively provide the functionalities described herein. In some embodiments, system 1000 may comprise one or more replicated and/or distributed physical or logical devices.

In some embodiments, system 1000 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 1000 includes a bus 1002 interconnecting several components including a network interface 1008, a display 1006, a central processing unit 1010, and a memory 1004.

Memory 1004 generally comprises a random access memory (“RAM”) and permanent non-transitory mass storage device, such as a hard disk drive or solid-state drive. Memory 1004 stores an operating system 1012.

These and other software components may be loaded into memory 1004 of system 1000 using a drive mechanism (not shown) associated with a non-transitory computer-readable medium 1016, such as a DVD/CD-ROM drive, memory card, network download, or the like.

Memory 1004 also includes database 1014. In some embodiments, system 1000 may communicate with database 1014 via network interface 1008, a storage area network (“SAN”), a high-speed serial bus, and/or via the other suitable communication technology. The memory 1004 may include logic for operating the operating system 1012, process for extending machine learning to edge devices 200, a scanner 1018, a rule compactor 124, a finite state machine 700, and a database 1014.

In some embodiments, database 1014 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

Those having skill in the art will appreciate that there are various logic implementations by which processes and/or systems described herein can be affected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

What is claimed is:

1. A method for extending machine learning to edge devices comprising:
generating a machine state model for at least one machine system from device data comprising diagnostic parameter values received from at least one edge device, through operation of a state machine modeler;
applying the machine state model to a rule compactor to construct a rule set, comprising:
extracting a plurality of machine states, transitions, transition probabilities, and state values associated with each of the machine states from the machine state model;
configuring a remediation parser with the state values to extract available remedial transitions for each of the machine states from the transitions based on the values of the state value for a starting state relative to an ending state;
ranking the remedial transitions based on the transition probabilities associated with the remedial transition; and
generating the rule set to encode the activation of the remedial transitions in rank order based upon the machine state; and
transmitting the rule set to a communications engine client to update a rules engine on the at least one edge device for controlling the at least one edge device.

2. The method of claim 1 further comprising:
operating a state extractor to:
compare the machine states, the transitions, and the state values of the machine state model to historical device data;
identify diagnostic parameters associated with the transitions and the state values of an absorptive negative machine state; and
configure the state machine modeler with identified diagnostic parameters to generate a modified machine state model.

3. The method of claim 2, wherein the historical device data is from an individual machine system.

4. The method of claim 2, wherein the historical device data is for a subset of similar machine systems.

5. The method of claim 1, wherein the state machine modeler utilizes an ensemble model.

6. The method of claim 1 wherein the rule set further comprises a set of triggers based on a machine system's possible states, the amount of time spent in those states, and the transitions between states.

7. The method of claim 1 wherein the remedial transition is the transition applied in a direction opposite from the transition's original direction.

8. The method of claim 1, wherein the rule set further comprises a set of triggers based on a machine's possible states, the amount of time spent in those states and the transitions between states.

9. The method of claim 1, wherein the remedial transition further comprises an action which may be implemented to force a machine to transition to a more positive state.

10. A non-transitory computer-readable storage medium, the computer-readable storage medium including instructions that when executed by a computer, cause the computer to:
generate a machine state model for at least one machine system from device data comprising diagnostic parameter values received from at least one edge device, through operation of a state machine modeler;
apply the machine state model to a rule compactor to construct a rule set, comprising:
extract a plurality of machine states, transitions, transition probabilities, and state values associated with each of the machine states from the machine state model;
configure a remediation parser with the state values to extract available remedial transitions for each of the machine states from the transitions based on the values of the state value for a starting state relative to an ending state;
rank the remedial transitions based on the transition probabilities associated with the remedial transition; and
generate the rule set to encode the activation of the remedial transitions in rank order based upon the machine state; and
transmit the rule set to a communications engine client to update a rules engine on the at least one edge device for controlling the at least one edge device.

11. The computer-readable storage medium of claim 10 wherein the instructions further configure the computer to:
operate a state extractor to:
compare the machine states, the transitions, and the state values of the machine state model to historical device data;
identify diagnostic parameters associated with the transitions and the state values of an absorptive negative machine state; and
configure the state machine modeler with identified diagnostic parameters to generate a modified machine state model.

12. The computer-readable storage medium of claim 11, wherein the historical device data is from an individual machine system.

13. The computer-readable storage medium of claim 11, wherein the historical device data is for a subset of similar machine systems.

14. The computer-readable storage medium of claim 10, wherein the state machine modeler utilizes an ensemble model.

15. The computer-readable storage medium of claim 10 wherein the rule set further comprises a set of triggers based on a machines possible states, the amount of time spent in those states, and the transitions between states.

16. The computer-readable storage medium of claim 10 wherein the remedial transition is the transition applied in a direction opposite from the transition's original direction.

17. The computer-readable storage medium of claim 10, wherein the rule set further comprises a set of triggers based on a machine's possible states, the amount of time spent in those states and the transitions between states.

18. The computer-readable storage medium of claim 10, wherein the remedial transition further comprises an action which may be implemented to force a machine to transition to a more positive state.
